(19) United States
(12) Patent Application Publication
(10) Pub. No.: US 2013/0090988 A1
(43) Pub. Date: Apr. 11, 2013

(54) DEFINING A MARKDOWN EVENT USING STORE CLUSTERING METHODOLOGY

(71) Applicant: REVIONICS, INC., Roseville, CA (US)

(72) Inventors: Jeffrey Moore, Phoenix, AZ (US); Milton Moskowitz, Mesa, AZ (US); Craig Morris, Cave Creek, AZ (US)

(73) Assignee: REVIONICS, INC., Roseville, CA (US)

(21) Appl. No.: 13/645,196

(22) Filed: Oct. 4, 2012

Related U.S. Application Data
(60) Provisional application No. 61/544,075, filed on Oct. 6, 2011.

(51) Int. Cl. G06Q 30/02

(52) U.S. Cl. 705/7.35

(57) ABSTRACT

A markdown definition process is performed on a system executing code contained on a computer-readable storage medium to define a markdown event for a plurality of stores. The markdown definition process includes computing initial markdown schedules for products eligible for a markdown event, where an initial markdown schedule is computed for each store. The stores are categorized into store clusters in accordance with the initial markdown schedules so that stores having the greatest degree of commonality are grouped together. Final markdown schedules are determined for the markdown event, where a final markdown schedule is determined for each store cluster. Each final markdown schedule includes optimized markdown solutions specific to one of the store clusters for the products eligible for the markdown event. The final markdown schedules are provided to the stores, so that each of the stores categorized into one of the store clusters receives the same final markdown schedule.

### TECHNICAL FIELD OF THE INVENTION

The present invention relates generally to markdown optimization. More specifically, the present invention relates to optimizing a markdown event utilizing store clustering.

### BACKGROUND OF THE INVENTION

Successful retailers plan the best strategies, including setting optimal base pricing, initiating promotional events, and executing markdown events in order to improve revenue, profit, and customer loyalty. In general, a markdown event is a period of time with a set of associated products and stores identified for inventory clearance. A markdown event may be performed to sell excess seasonal or discontinued items, to sell aged packaging and date-coded products, to execute category resets, to reduce overstock products, and so forth. Critical to maximizing margin, sell-through, and inventory value is determining when to begin markdown events, initial price reduction for the products, a schedule for subsequent price reductions, and a plan for implementing a markdown event in multiple stores.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of a system for defining a markdown event in accordance with an embodiment;

FIG. 2 shows a flowchart of a markdown definition process executed by the system of FIG. 1;

FIG. 3 shows a diagram of stores and their associated markdown schedules used to illustrate an exemplary execution of the markdown definition process;

FIG. 4 shows a diagram defining a distortion metric that is used during execution of the markdown definition process;

FIG. 5 shows a diagram of a first iteration of a store categorization feature of the markdown definition process;

FIG. 6 shows a diagram of a second iteration of the store categorization feature of the markdown definition process;

FIG. 7 shows a diagram of a third iteration of the store categorization feature of the markdown definition process;

FIG. 8 shows a diagram of a fourth iteration of the store categorization feature of the markdown definition process;

FIG. 9 shows a diagram of a fifth iteration of the store categorization feature of the markdown definition process;

FIG. 10 shows a diagram of a sixth iteration of the store categorization feature of the markdown definition process;

FIG. 11 shows a diagram of a seventh iteration of the store categorization feature of the markdown definition process;

FIG. 12 shows a diagram of a final outcome of the exemplary execution of the markdown definition process; and

FIG. 13 shows a diagram of an exemplary final markdown schedule provided to one of the store clusters.

### DETAILED DESCRIPTION

The optimization of markdown events provides an opportunity to maximize margin, sell-through, and inventory value while improving freshness and velocity (i.e., the speed of movement) of product assortment. Indeed, markdown optimization may be leveraged for category resets, overstock reductions, location closings, aged packaging and date-coded products, as well as for optimizing the sale of selling seasonal or discontinued items.

Some retailers group their retail facilities, referred to herein as stores, into zones or clusters based on demographic information and competitor proximity. A single markdown event may then take place within these grouped stores. The prior art techniques for grouping stores are relatively fixed, and may not take into account the current inventory or demand characteristics of a specific set of products at a specific point in time.

Embodiments entail a system, a computer-readable storage medium containing executable code, and methodology for defining a markdown event for a plurality of stores. In particular, the system and methodology allow a large markdown event consisting of many products and stores to be clustered in order to maximize value, subject to a constraint in the allowable number of distinct markdown schedules. The stores are clustered by markdown event to reflect store-based inventory, item elasticity, and consumer demand. Consequently, each store within a store cluster receives a common markdown schedule, i.e., the specification of dates and marks (e.g., prices, amount off marks, or percent off marks), for a markdown event. The stores are clustered in such a way so as to maximize the performance of markdown optimization for the resulting store clusters. Furthermore, the store clusters can be dynamically recategorized to take into account current inventories and sales data.

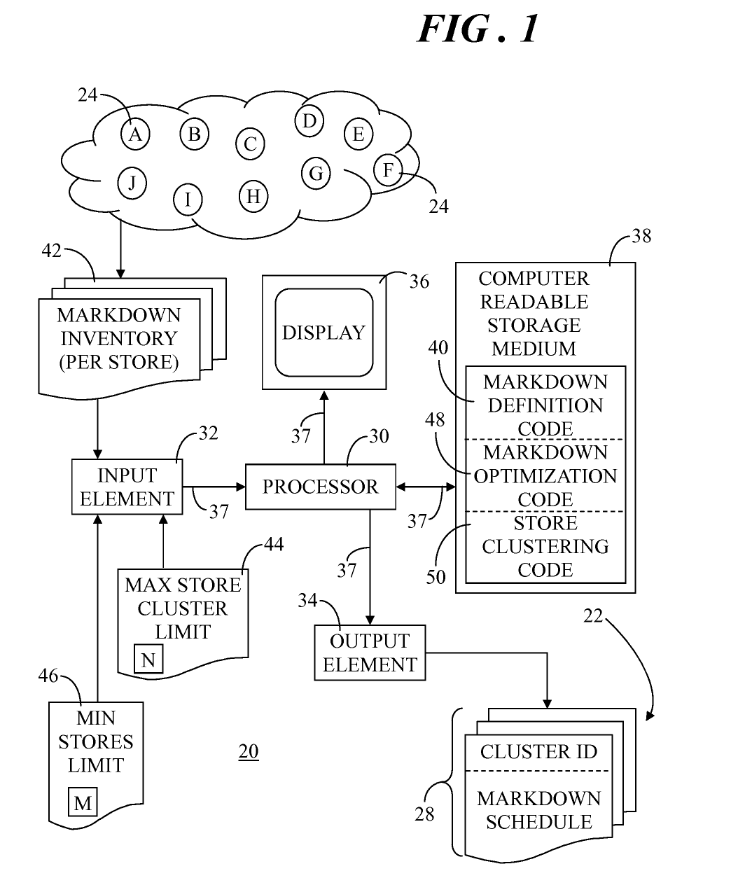

FIG. 1 shows a block diagram of a computing system 20 for defining a markdown event 22 in accordance with an embodiment. Markdown event 22 refers to a period of time during which markdown pricing occurs for a set of products and stores. In accordance with an embodiment, stores 24 are categorized into store clusters (discussed below). Markdown event 22 is thus characterized by a number of markdown schedules 28, where each store 24 within a store cluster receives a common, i.e., the same, markdown schedule 28.

For illustrative purposes, FIG. 1 is shown with ten stores 24, each of which is identified by a unique letter A through J. These ten stores 24 are used to demonstrate methodology in accordance with an embodiment. In actual practice, a retailer may have more or less than ten stores 24 for which markdown events 22 are to be defined. In the instance where a retailer may have a multiplicity of stores at which a markdown events 22 are to be scheduled, methodology described below categorizes stores 24 into distinct store clusters to optimize markdown schedules and pricing for a group of stores, taking into account the current inventory and demand characteristics.

Computing system 20 includes a processor 30 on which the methods according to the invention can be practiced. Processor 30 is in communication with an input element 32, an output element 34, and a display 36. These elements may be interconnected by a bus structure 37.

Input element 32 can encompass a keyboard, mouse, pointing device, audio device (e.g., a microphone), and/or any other device providing input to processor 30. Output element 34 can encompass a printer, an audio device (e.g., a speaker), and/or other devices providing output from processor 30. Input and output elements 32 and 34 can also include network connections, modems, or other devices used for communications with other computer systems or devices via a communication network (not shown) such as an organization specific intranet or the ubiquitous Internet.

Computing system 20 also includes a computer-readable storage medium 38 in communication with processor 30. Computer-readable storage medium 38 may be a magnetic disk, compact disk, or any other volatile or non-volatile mass storage system readable by processor 30. Computer-readable storage medium 38 may also include cooperating or interconnected computer readable media, which exist exclusively on computing system 20 or are distributed among multiple interconnected computer systems (not shown) that may be local or remote.

Markdown definition code 40 is stored on computer-readable storage medium 38 and is executed by processor 30. In general, markdown definition code 40 instructs processor 30 to define markdown event 22 for a plurality of stores 24 by categorizing stores 24 into store clusters, subject to user provided constraints. Markdown definition code 40 uses data specific to individual stores 24. Of particular interest for input into markdown definition code 40 executed at computing system 20, is markdown inventory data 42. Markdown inventory data 42 can include a list of products, inventory, and so forth that are eligible for inclusion in markdown event 22. Distinct inventory data 42 may be specified for each store 24 for a given retailer and can be received at computing system 20 via input element 32.

The user provided constraints for implementation in markdown definition code 40 includes a first constraint 44, labeled “N,” and a second constraint 46, labeled “M.” First constraint 44 defines a predetermined total allowable quantity of store clusters that may be formed. Thus, first constraint 44 is referred to hereinafter as a maximum store cluster limit 44. Second constraint 46 defines a predetermined minimum quantity of stores in each store cluster. Thus, second constraint 46 is referred to hereinafter as a minimum stores limit 46. Maximum store cluster limit 44 and minimum stores limit 46 may be entered by an analyst via input element 32 during execution of markdown inventor data 42, and will be discussed in greater detail below.

Markdown definition code 40 employs markdown optimization code 48 and store clustering code 50, both of which will be described in greater detail below. Execution of markdown definition code 40 produces a distinct markdown schedule 28 optimized for each cluster, or grouping, of stores 24, and each store 24 within a store cluster receives the same markdown schedule 28. Markdown schedules 28 may be provided to stores 24 via output element 34.

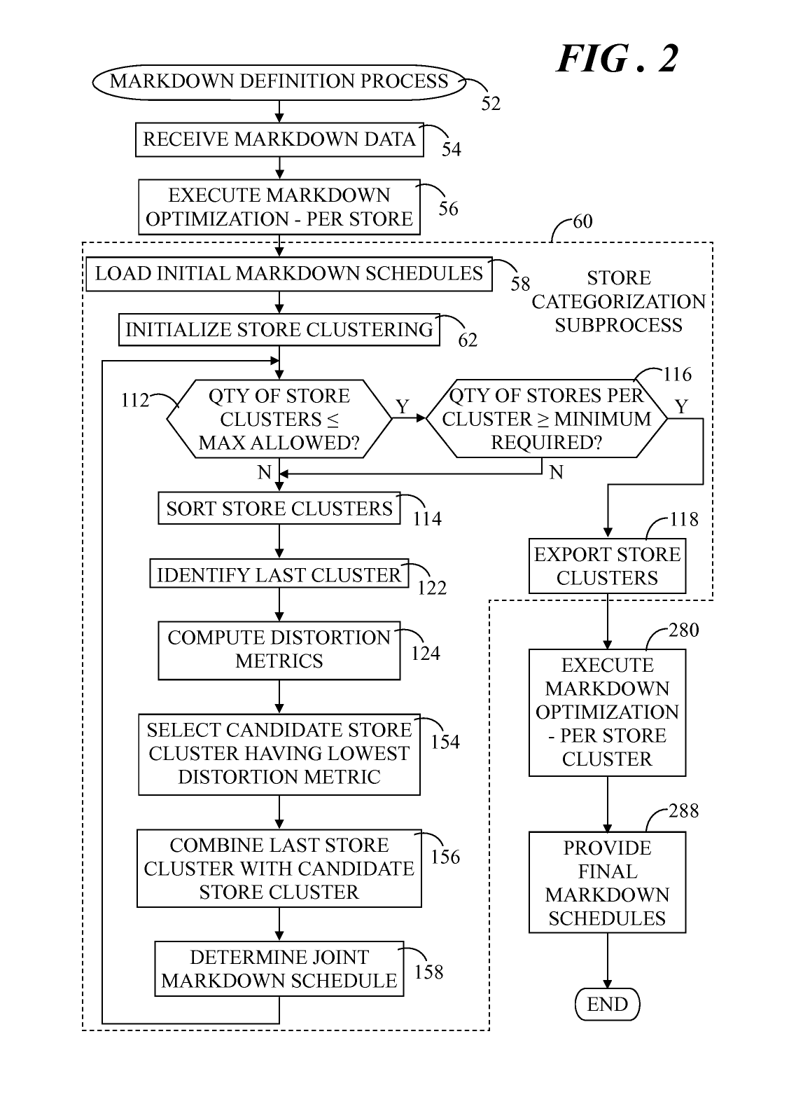

FIG. 2 shows a flowchart of a markdown definition process 52 executed by computing system 20 (FIG. 1). Markdown definition process 52 is embodied as markdown definition code 40 (FIG. 1) contained on computer-readable storage medium 38 (FIG. 1) and is executed by processor 30 (FIG. 1). Process 52 describes computer-assisted methodology for defining markdown event 22, including categorizing stores 24 into store clusters and providing optimized markdown schedules 28 on a per store cluster basis.

Markdown definition process 52 begins with a task 54. At task 54, computing system 20, executing markdown definition code 40 (FIG. 1) receives markdown inventory data 42 (FIG. 1). Markdown inventory data 42 can include a listing of products eligible for markdown event 22 (FIG. 1) and inventories by product. Markdown inventory data 42 is received from each of stores 24 via wired and/or wireless data communications links, and so forth.

In response to task 54, markdown definition process 52 continues with a task 56. At task 56, markdown optimization code 48 (FIG. 1) is executed per store using markdown inventory data 42. In general, a markdown optimizer (i.e., markdown optimization code 48) is a software program that uses current inventory, a predictive model for customer demand, and a set of defined business rules to recommend a markdown schedule (dates and prices) for a set of products in a set of stores. The outputs from a markdown optimization code 48 can include recommended dates and depths of markdown pricing actions as well as time-based forecasts of demand and inventory position.

The purpose of markdown optimization code 48 is to maximize a business objective (usually a combination of profit and terminal inventory position, or “sell through”) for an identified volume of inventory targeted for clearance by a certain date. The inventory identified for clearance may be less than one hundred percent of the full volume of currently-available inventory. A predictive model for customer demand is necessary to project volume sold as a function of time and price (or markdown depth). Typically volume sold is projected by the model to increase with increasing price incentive such that greater sell-through can be achieved by taking deeper markdowns at the expense of per-unit profitability (and potentially overall profitability).

Markdown optimization code 48 uses a set of business rules. The business rules are a set of guidelines and constraints that cause markdown optimization code 48 to produce markdown schedules that can be feasibly executed by the business. Some examples of markdown optimization business rules include:
“Schedule coherence”—Sets of products and stores that are required to have the same markdown schedules for ease of implementation, signage, or labor savings.
Allowed markdown days—Specific days of the week or month that are allowed/scheduled for markdown pricing actions (can vary by store).
Minimum and maximum time between markdown actions.
Save story specification—Defines whether markdown prices are defined in terms of percent off (e.g. “25% off regular price”), amount off (e.g. “$1.00 off original price”), or price point (e.g. “$7.99, regularly $9.99”). The save story specification defines both how price discounts are specified and the lattices of allowed pricing actions (e.g., 25%, 33%, 50%, 75% and 90% are the only allowed markdown depths).
Minimum and maximum allowed difference between markdown steps, minimum margin, rules related to minimum and maximum markdown depths for first and last markdowns, etc.
Salvage value—specification of the per-unit value of inventory remaining at the end of a markdown period.

Thus, markdown optimization code 48 can take into account price responsiveness, seasonality, holiday demand patterns, promotional response, and inventory levels by product and store 24. Markdown optimization code 48 ideally recommends markdown schedules that satisfy all of the specified business rules, or notifies users when rules must be violated to produce a feasible solution. Markdown optimizers, such as markdown optimization code 48, will typically provide capabilities for evaluating the “cost of rules” (i.e. the extent to which enforcement of specific rules impacts the business value for a given markdown solution).

Execution of markdown optimization code 48 at task 56 of markdown definition process 52 produces a set of initial markdown schedules, where one each of the markdown schedules is associated with one each of stores 24 (FIG. 1). Thus, markdown optimization code 48 is executed in an unconstrained manner, where each store 24 is able to assert its own cadence in order to produce an optimization solution for that store 24. By leveraging an unconstrained optimization solution as a precursor to a clustered solution (discussed below), computing system 20 (FIG. 1) is able to identify commonality among stores 24 based on predicted demand patterns.

Markdown definition process 52 continues with a task 58. At task 58, the initial markdown schedules produced at task 56 are loaded into store clustering code 50 of markdown definition code 38. Beginning with task 58 and the subsequent tasks of markdown definition process 52 exemplify operations of the store clustering code 50 portion of markdown definition code 38. This set of tasks is distinguished by a dashed line box and is referred to herein as a store categorization subprocess 60 of markdown definition process 52. Store categorization subprocess 60 is executed to categorize stores 24 into store clusters in accordance with the initial markdown schedules produced in response to the execution of markdown optimization code 48 at task 56.

Accordingly, in response to task 58, a task 62 is performed to initialize store clustering. At task 62, processor 30 receives a value for maximum store cluster limit 44 (FIG. 1) and minimum stores limit 46 (FIG. 1) from a user of computing system 20 via input element 32 (FIG. 1). In addition, processor 30 organizes the set of stores 24 and their associated initial markdown schedules into a particular order.

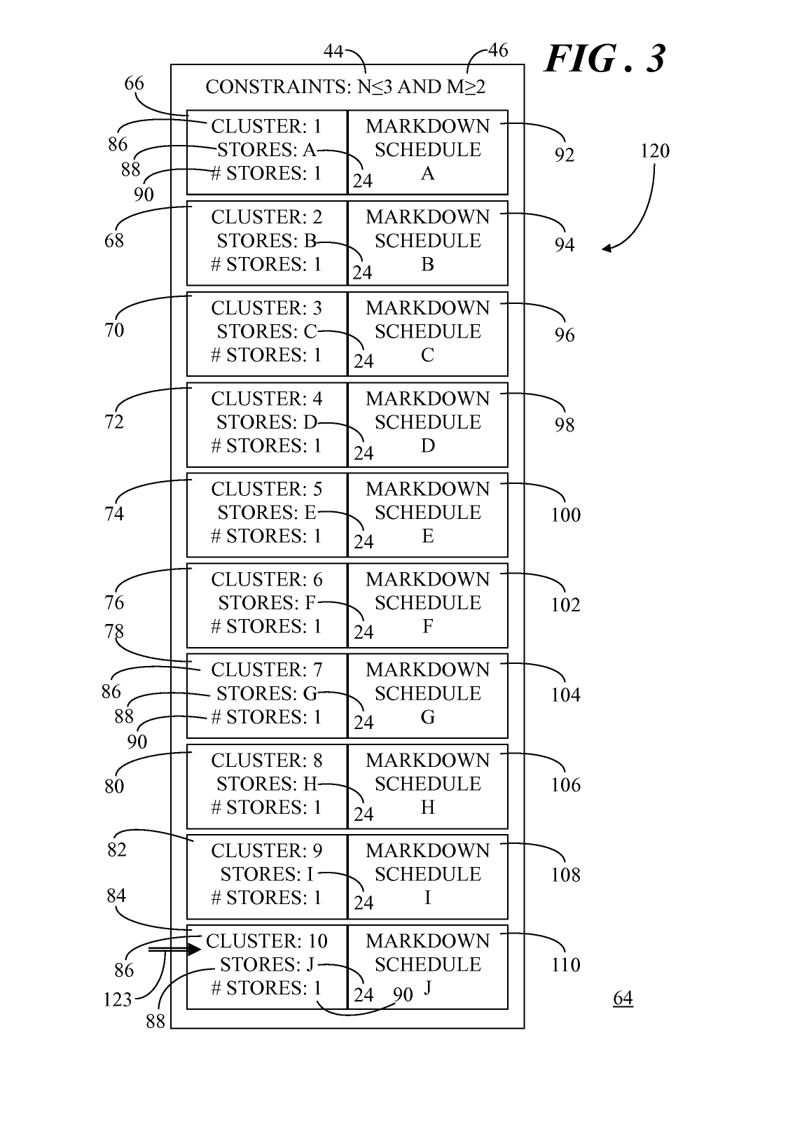

Referring to FIG. 3 in connect with task 60, FIG. 3 shows a diagram 64 listing a set of stores 24 and their associated initial markdown schedules used to illustrate an exemplary execution of markdown process 52. Diagram 64 includes a set of store clusters 66 through 84. Accordingly, each store cluster 66 through 84 is identified by a cluster identifier 86. A store identifier 88 representing stores 24 currently included in that store cluster 66-84 is associated with cluster identifier 86. Additionally, a total store count value 90 specifying the total number of stores 24 currently included in that store cluster 66-84 is associated with cluster identifier 86.

In response to initialization task 60 at the onset of execution of store categorization subprocess 60, each of store clusters 66-84 includes a single store 24. By way of example, store cluster 66 includes cluster identifier 86 of “1”, store identifier 88 of “A,” and store count value 90 of “1.” In another example, store cluster 78 includes cluster identifier 86 of “7”, store identifier 88 of “G,” and store count value 90 of “1.”

An initial markdown schedule 92 through 110 is associated with each store cluster 66-84. Initial markdown schedules 92-110 were produced in response to execution of markdown optimization code 48 (FIG. 1) at task 56 (FIG. 2). By way of example, initial markdown schedule 92, labeled “A,” is associated with store cluster 66, initial markdown schedule 94, labeled “B,” is associated with store cluster 68, and so forth. Initial markdown schedules 92-110 represent the unconstrained markdown optimization solution on a per store basis.

Diagram 64 further includes user specified values for maximum store cluster limit 44 and minimum stores limit 46. In this example, a user specified that the quantity, N, of store clusters 66-84 should not exceed three. In addition, the user specified that the quantity of stores, M, in each of store clusters 66-84 should be at least two. Subsequent operations of categorization subprocess 60 of markdown definition 52 process (FIG. 2) combine store clusters 66-84 to satisfy limits 44 and 46. In particular, categorization subprocess 60 utilizes initial markdown schedules 92-110 to perform an agglomerative hierarchical clustering process to group stores 24 into store clusters with the greatest degree of commonality in their initial markdown schedules 92-110, where the quantity of store clusters and the quantity of stores 24 in each store cluster satisfy the user defined constraints 44 and 46. In general, hierarchical clustering is a method of cluster analysis which seeks to build a hierarchy of clusters, in this case store clusters or groups of stores 24. Agglomerative hierarchical clustering is a “bottom up” approach, where each observation, in this case each store 24, starts in its own cluster, and clusters are merged as one moves up the hierarchy.

Now referring back to FIG. 2, following task 62, markdown definition process 52 continues with a query task 112. At query task 112, a determination is made as to whether the total quantity of store clusters is less than or equal to the maximum allowed store clusters, i.e., limit 44 (FIG. 3). When a total quantity of store clusters is greater than the value of maximum store cluster limit 44, process 52 continues with a task 114 (discussed below). However, when the total quantity of store clusters is less than or equal to maximum store cluster limit 44, markdown definition process 52 continues with a query task 116.

At query task 116, a determination is made as to whether the total store count in each of the store clusters is greater than or equal to the minimum allowed store count, i.e., minimum stores limit 46 (FIG. 3). When a total quantity of stores in any of the store clusters is less than the value of minimum stores limit 46, process 52 also continues with task 114. Alternatively, when the total quantity of stores in each of the store clusters is equal to or greater than the value of minimum stores limit 46, markdown definition process 52 continues with a task 118 (discussed below).

Thus, query task 112 is executed to determine whether a first constraint, namely maximum store cluster limit 44, is satisfied and query task 116 is executed to determine whether the second constraint, namely minimum stores limit 46 is satisfied. As a result, after achieving the desired number of store clusters, execution of store categorization subprocess 60 enforces the minimum size requirement by further combining store clusters until all store clusters meet minimum stores limit 46. This may result in fewer store clusters than maximum store cluster limit 44. Markdown definition process 52 continues to task 118 only when both constraints are satisfied.

As mentioned previously, task 114 is performed when at least one of maximum store cluster limit 44 and minimum stores limit 46 is not satisfied. At task 114, the store clusters are sorted by size, i.e., by store count value 90, in a descending order. Of course, during a first iteration of task 114, each of store clusters 66-84 has the same store count value 90 of one. That is, the quantity of store clusters is the same as the quantity of stores. Thus, during a first iteration of task 114, store clusters 66-84 may be sorted in accordance with any desired criteria. Referring briefly to FIG. 3, store clusters 66-84 are initially sorted into a numerical order 120 using cluster identifier 86. As store clusters 66-84 are grouped during the iterative process of store categorization subprocess 60, they will be iteratively re-sorted according to store count value 90 for each store cluster.

Following task 114, markdown definition process 52 continues with a task 122. At task 122, the “last” store cluster is identified. As shown in FIG. 3, the “last” store cluster in numerical order 120 is identified by an arrow 123. The “last” store cluster in order 120 is store cluster 84 having cluster identifier 86 of “10” that includes store 24 having store identifier 88 of “J” and store count value 90 of “1.”

A task 124 is performed in response to task 122. At task 124, distortion metrics are computed that relate the last store cluster, i.e. store cluster 84 (FIG. 3), to the remaining store clusters 66-82.

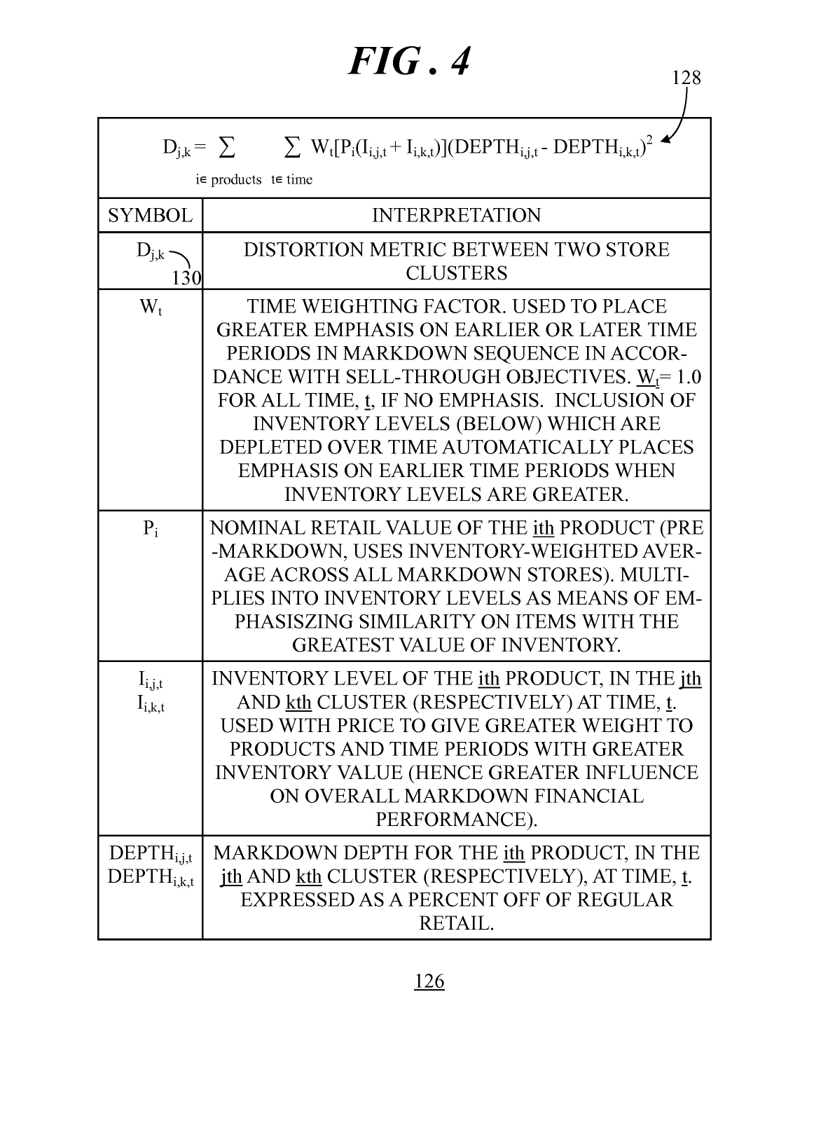

Referring to FIG. 4 in connection with task 124, FIG. 4 shows a diagram 126 defining a distortion metric equation 128 that may be used during execution of markdown definition process 20. In an embodiment, distortion metric equation 128 is utilized to compute a distortion metric value 130 between two store clusters, i.e., a degree of deviation imposed by combining store clusters. Distortion metric equation 128 measures the degree of difference between the markdown schedules of any two store clusters. Distortion metric equation 128 is defined such that minimizing the computed distortion metric value 130 will maximize the resulting optimization performance subject to the imposed constraint of maximum store cluster limit 44 (FIG. 1).

In accordance with distortion metric equation 128, identical markdown cadences, i.e., markdown schedules, have zero distortion (no penalty). That is, when two markdown schedules are identical (i.e., all products, dates, and depths are identical) for two store clusters, distortion metric value 130 will be zero. This reflects the fact that combining the two store clusters results in no degradation of the optimization benefits since the newly enforced constraint results in no change to either schedule.

In general, distortion metric equation 128 is a weighted sum-of-squared-error term. The squared error component reflects the difference in markdown depths (either as percentages or as whole dollar amounts). The term “depth” or alternatively “markdown depth” refers to the depth of a discount, typically expressed in terms of percent off of regular price. The weighting scheme implemented in distortion metric equation 128 emphasizes products and time periods with the greatest value of inventory, and hence, the greatest influence on the financial outcome of markdown event 22 (FIG. 1).

The hierarchical clustering feature of store categorization subprocess 60 iterates to combine markdown schedules in such a way so as to minimize distortion metric value 130, resulting in groups of stores, i.e., store clusters, with the greatest degree of commonality in their initial markdown schedules 92-110 (FIG. 3). This hierarchical clustering approach is termed “minimum distortion agglomerative clustering” herein because it allows low-level results to be combined (agglomerated) based on commonality of the initial markdown schedules 92-110.

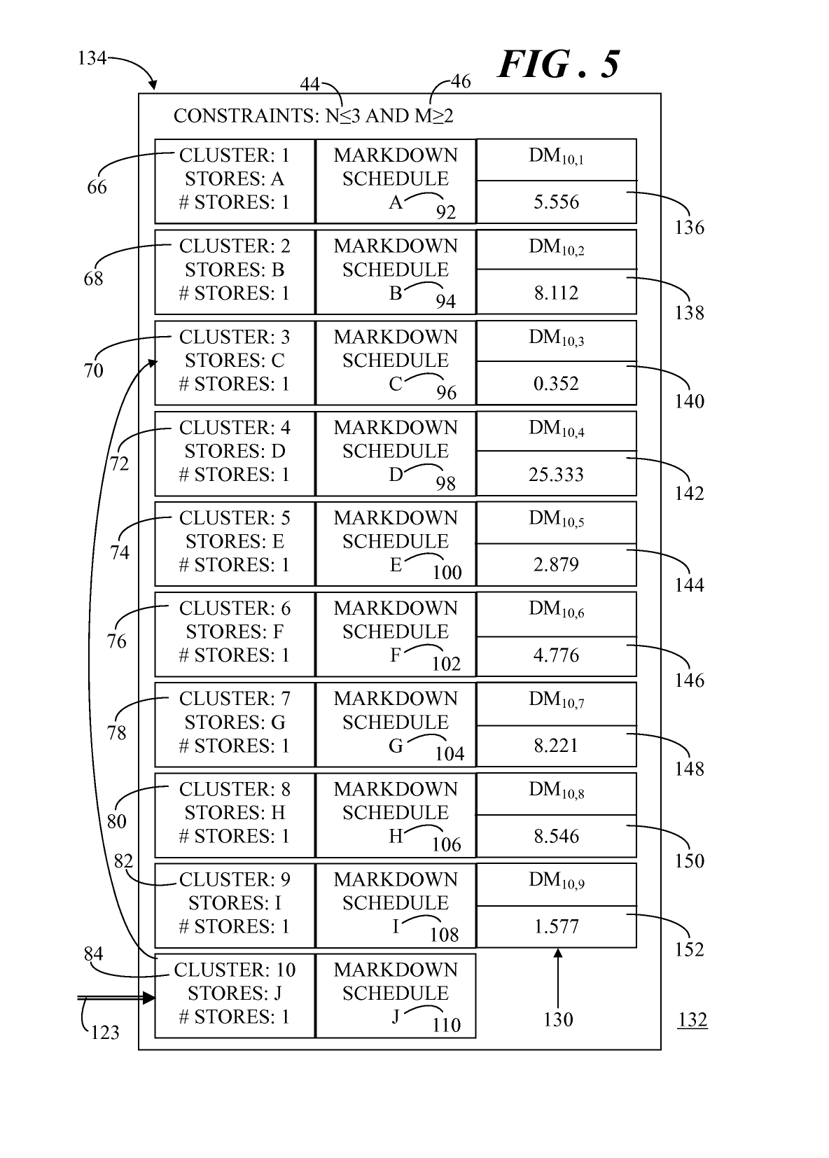

Now referring to FIG. 5 in connection with task 124 of markdown definition process 52 (FIG. 2), FIG. 5 shows a diagram 132 of a first iteration 134 of store categorization subprocess 60 (FIG. 2) of markdown definition process 52. Diagram 132 includes distortion metric values 130 that provide a measure of the degree of difference between initial markdown schedule 110 for store cluster 84 and initial markdown schedules 92-108 for the remaining store clusters 66-82.

A distinct distortion metric value 136 through 152 is associated with each of the remaining store clusters 66-82. Distortion metric values 136-152 were computed using distortion metric equation 128 (FIG. 4). In an example, distortion metric value 136 of 5.556 characterizes the degree of difference between initial markdown schedule 110 for store cluster 84 and initial markdown schedule 92 for store cluster 66.

With continued reference to FIGS. 2 and 5, following task 124 in which distortion metrics 136 through 152 were computed, markdown definition process 52 continues with a task 154. At task 154, a candidate store cluster is selected having the lowest distortion metric value. In the example presented in FIG. 5, diagram 132 reveals that store cluster 70 is a candidate store cluster because its corresponding distortion metric value 140 is lower than the remaining distortion metric values 136, 138, and 142-152. Thus, in this example, store cluster 70 is selected at task 154.

Following task 154, a task 156 is performed. At task 156, the last store cluster is combined with the candidate store cluster. Again, in the exemplary diagram 132, the last store cluster is store cluster 84 and the candidate store cluster is store cluster 70. Thus, store cluster 84 is combined (agglomerated) with store cluster 70 at task 156 to form a joint store cluster that contains both stores 24 identified by store identifiers 88 of “C” and “J”.

Next, a task 158 is performed. At task 158, a joint markdown schedule is determined for the newly formed joint store cluster. In an embodiment, the markdown schedule for the candidate store cluster may be imposed. As such, markdown schedule 96 for store cluster 70 may be imposed for the resulting joint store cluster that contains both stores 24 identified by store identifiers 88 of “C” and “J”. However, in alternative embodiments, other approaches for merging or defining a joint markdown schedule may be implemented.

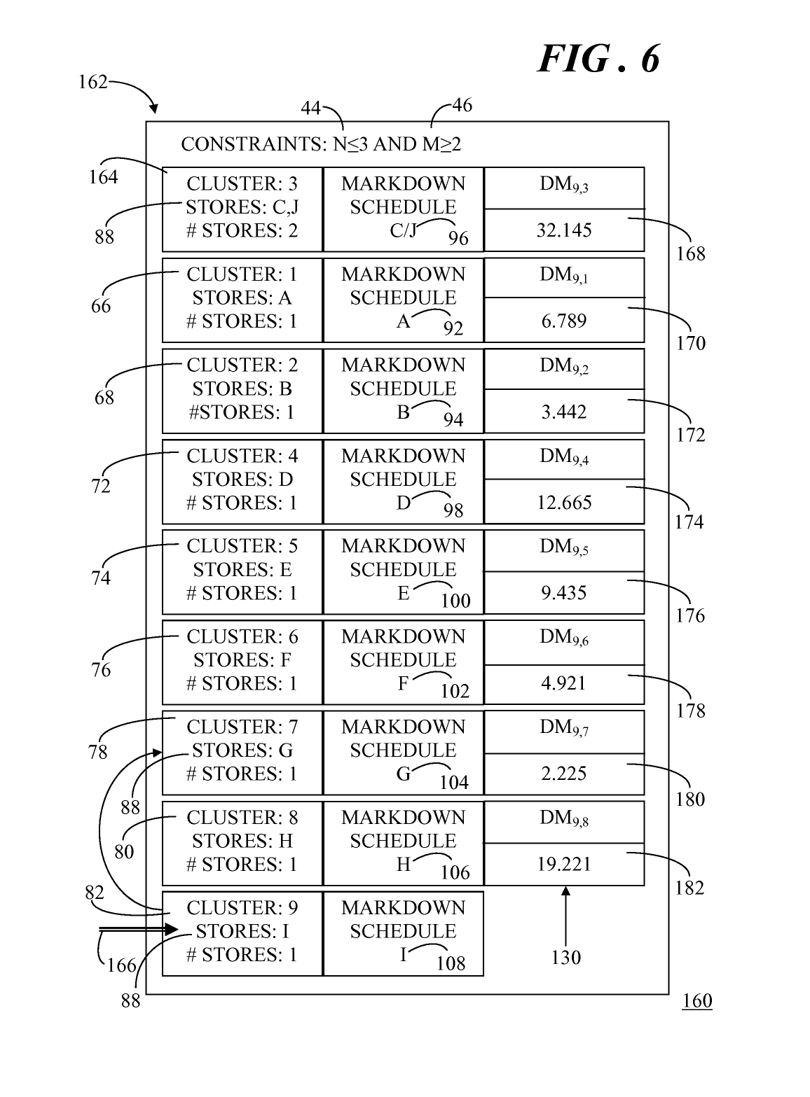

Following task 158, process control loops back to query task 112 to again determine whether the user imposed constraints of maximum store cluster limit 44 and minimum stores limit 46 have been met. As mentioned earlier, markdown definition process 52 continues to task 118 only when both constraints are satisfied. However, prior to discussion regarding task 118 and the tasks subsequent to task 118, the repeated iteration of tasks 114, 122, 124, 154, 156, and 158 will be described in accordance with an example presented in FIGS. 6-12.

Each of FIGS. 6-12 are discussed below. As FIGS. 6-12 are discussed, reference should additionally be made to markdown definition process 52 of FIG. 2.

FIG. 6 shows a diagram 160 of a second iteration 162 of store categorization subprocess 60 of markdown definition process 52. As a result of first iteration 134 (FIG. 5), a joint store cluster 164 containing two stores 24 having store identifiers 88 of “C” and “J” has been formed. At sorting task 114, joint store is the first in the descending order of store clusters because it has the greatest size, i.e., it includes the most stores 24. Now store cluster 82 is identified as the last store cluster at task 122 as represented by an arrow 166.

Task 124 is executed to compute distortion metric values 168 through 182 between markdown schedule 108 for store cluster 82 and each of markdown schedules 92-106 for remaining store clusters 164 and 66-80. The candidate store cluster having the lowest distortion metric value is selected at task 154. At second iteration 162, the candidate store cluster is store cluster 78 having distortion metric value 180 of 2.225.

Task 156 is executed to combine the last store cluster with the candidate store cluster. Thus, store cluster 82 is combined (agglomerated) with store cluster 78 at second iteration 162 to form a joint store cluster that contains all stores 24 in store clusters 78 and 82. These stores 24 are identified by store identifiers 88 of “G” and “I” Task 158 is then executed to determine a joint markdown schedule for the newly formed joint store cluster. In keeping with the methodology discussed above, markdown schedule 104 for store cluster 78 will be imposed on the newly formed joint store cluster. Again, program control loops back to query task 112 to determine whether both user imposed constraints, namely, maximum store cluster limit 44 and minimum stores limit 46 have been satisfied.

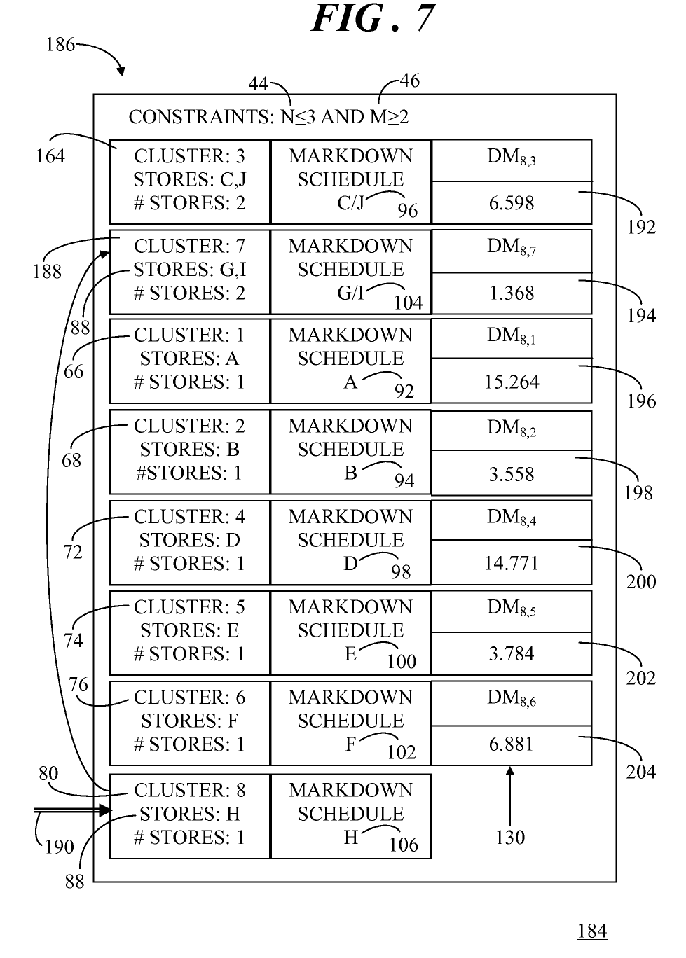

FIG. 7 shows a diagram 184 of a third iteration 186 of store categorization subprocess 60 of markdown definition process 52. As a result of second iteration 162 (FIG. 6), a joint store cluster 188 containing two stores 24 having store identifiers 88 of “G” and “I” has been formed. At sorting task 114, joint store cluster 188 is sorted to a position that is second in the descending order of store clusters since it includes more stores 24 than store clusters 66, 68, 72, 74, 76, and 80 and the same quantity of stores 24 as store cluster 164. Now store cluster 80 is identified as the last store cluster at task 122 as represented by an arrow 190.

Task 124 is executed to compute distortion metric values 192 through 204 between markdown schedule 106 for store cluster 80 and each of markdown schedules 96, 104, 92, 94, 98, 100, and 102 for remaining store clusters 164, 188, 66, 68, 72, 74, and 76. The candidate store cluster having the lowest distortion metric value is selected at task 154. At third iteration 186, the candidate store cluster is store cluster 188 having distortion metric value 194 of 1.368.

Task 156 is executed to combine the last store cluster with the candidate store cluster. Thus, store cluster 80 is combined (agglomerated) with store cluster 188 at third iteration 186 to form a joint store cluster that contains all stores 24 in store clusters 188 and 80. These stores 24 are identified by store identifiers 88 of “G”, “I,” and “H.” Task 158 is then executed to determine a joint markdown schedule for the newly formed joint store cluster. In keeping with the methodology discussed above, markdown schedule 104 for store cluster 188 will be imposed on the newly formed joint store cluster. Again, program control loops back to query task 112 to determine whether both user imposed constraints, namely, maximum store cluster limit 44 and minimum stores limit 46 have been satisfied.

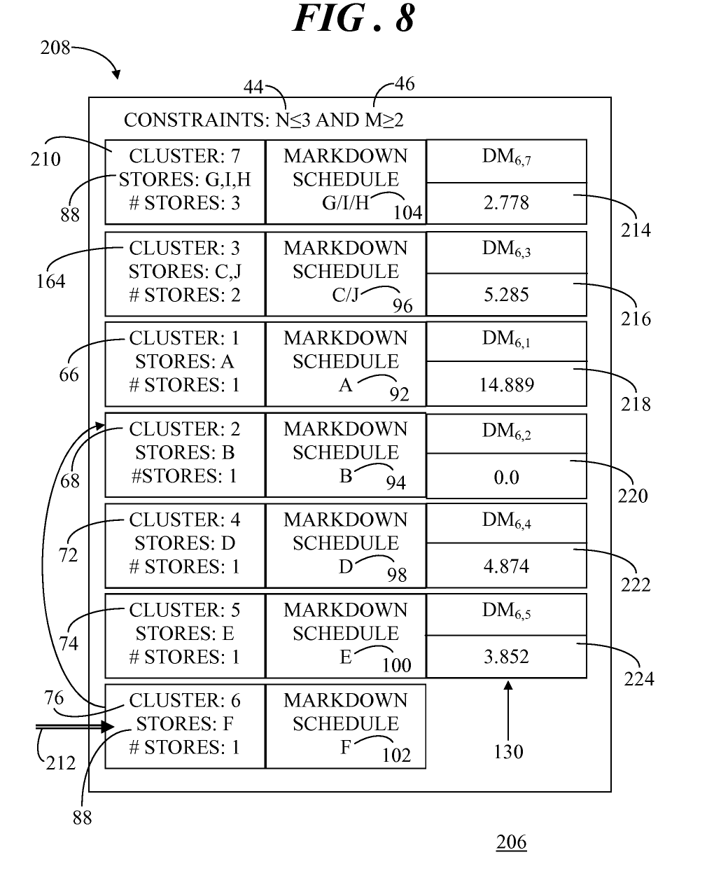

FIG. 8 shows a diagram 206 of a fourth iteration 208 of store categorization subprocess 60 of markdown definition process 52. As a result of third iteration 186 (FIG. 7), a joint store cluster 210 containing three stores 24 having store identifiers 88 of “G,” “I,” and “H” has been formed. At sorting task 114, joint store cluster 210 is sorted to a position that is first in the descending order of store clusters since it includes more stores 24 than all of the remaining store clusters 164, 66, 68, 72, 74, and 76. Now store cluster 76 is identified as the last store cluster at task 122 as represented by an arrow 212.

Task 124 is executed to compute distortion metric values 214 through 224 between markdown schedule 102 for store cluster 76 and each of markdown schedules 104, 96, 92, 94, 98, 100, and 102 for remaining store clusters 210, 164, 66, 68, 72, and 74. The candidate store cluster having the lowest distortion metric value is selected at task 154. At fourth iteration 208, the candidate store cluster is store cluster 68 having distortion metric value 220 of 0.0 (indicating that initial markdown schedules 94 and 102 are identical).

Task 156 is executed to combine the last store cluster with the candidate store cluster. Thus, store cluster 76 is combined (agglomerated) with store cluster 68 at fourth iteration 208 to form a joint store cluster that contains all stores 24 in store clusters 68 and 76. These stores 24 are identified by store identifiers 88 of “B” and “F.” Task 158 is then executed to determine a joint markdown schedule for the newly formed joint store cluster. In keeping with the methodology discussed above, markdown schedule 94 for store cluster 68 will be imposed on the newly formed joint store cluster. Again, program control loops back to query task 112 to determine whether both user imposed constraints, namely, maximum store cluster limit 44 and minimum stores limit 46 have been satisfied.

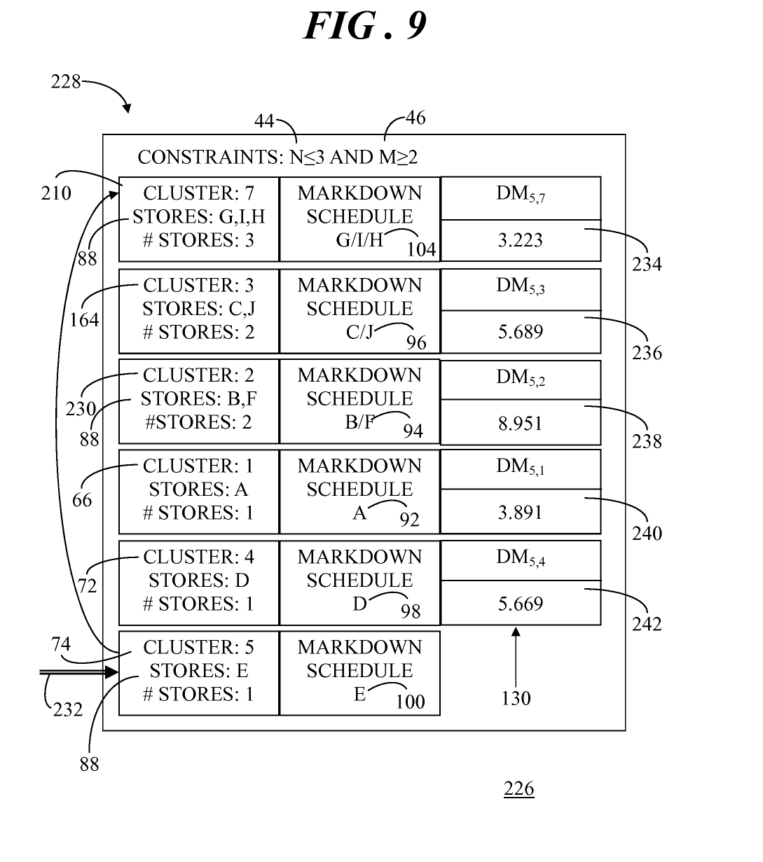

FIG. 9 shows a diagram 226 of a fifth iteration 228 of store categorization subprocess 60 of markdown definition process 52. As a result of fourth iteration 208 (FIG. 8), a joint store cluster 230 containing two stores 24 having store identifiers 88 of “B,” and “F” has been formed. At sorting task 114, joint store cluster 230 is sorted to a position that is third in the descending order of store clusters. Now store cluster 74 is identified as the last cluster at task 122 as represented by an arrow 232.

Task 124 is executed to compute distortion metric values 234 through 242 between markdown schedule 100 for store cluster 74 and each of markdown schedules 104, 96, 94, 92, and 98 for remaining store clusters 210, 164, 230, 66, and 72. The candidate store cluster having the lowest distortion metric value is selected at task 154. At fifth iteration 228, the candidate store cluster is store cluster 210 having the lowest distortion metric value 234.

Task 156 is executed to combine the last store cluster with the candidate store cluster. Thus, store cluster 74 is combined (agglomerated) with store cluster 210 at fifth iteration 228 to form a joint store cluster that contains all stores 24 in store clusters 74 and 210. These stores 24 are identified by store identifiers 88 of “G,” “I,” “H,” and “E.” Task 158 is then executed to determine a joint markdown schedule for the newly formed joint store cluster. In keeping with the methodology discussed above, markdown schedule 104 for store cluster 210 will be imposed on the newly formed joint store cluster. Again, program control loops back to query task 112 to determine whether both user imposed constraints, namely, maximum store cluster limit 44 and minimum stores limit 46 have been satisfied.

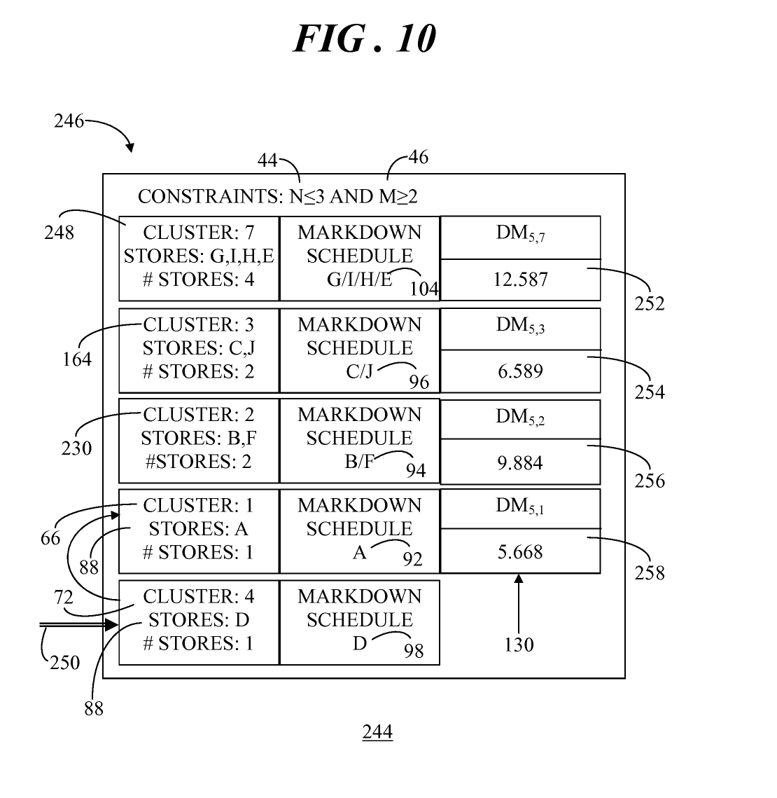

FIG. 10 shows a diagram 244 of a sixth iteration 246 of store categorization subprocess 60 of markdown definition process 52. As a result of fifth iteration 228 (FIG. 9), a joint store cluster 248 containing four stores 24 having store identifiers 88 of “G,” “I,” “H,” and “E” has been formed. At sorting task 114, joint store cluster 248 is sorted to a position that is first in the descending order of store clusters. Now store cluster 72 is identified as the last cluster at task 122 as represented by an arrow 250.

Task 124 is executed to compute distortion metric values 252 through 258 between markdown schedule 98 for store cluster 72 and each of markdown schedules 104, 96, 94, and 92 for remaining store clusters 248, 164, 230, and 66. The candidate store cluster having the lowest distortion metric value is selected at task 154. At sixth iteration 246, the candidate store cluster is store cluster 66 having the lowest distortion metric value 258.

Task 156 is executed to combine the last store cluster with the candidate store cluster. Thus, store cluster 72 is combined (agglomerated) with store cluster 66 at sixth iteration 246 to form a joint store cluster that contains all stores 24 in store clusters 72 and 66. These stores 24 are identified by store identifiers 88 of “A” and “D.” Task 158 is then executed to determine a joint markdown schedule for the newly formed joint store cluster. In keeping with the methodology discussed above, markdown schedule 92 for store cluster 66 will be imposed on the newly formed joint store cluster. Again, program control loops back to query task 112 to determine whether both user imposed constraints, namely, maximum store cluster limit 44 and minimum stores limit 46 have been satisfied.

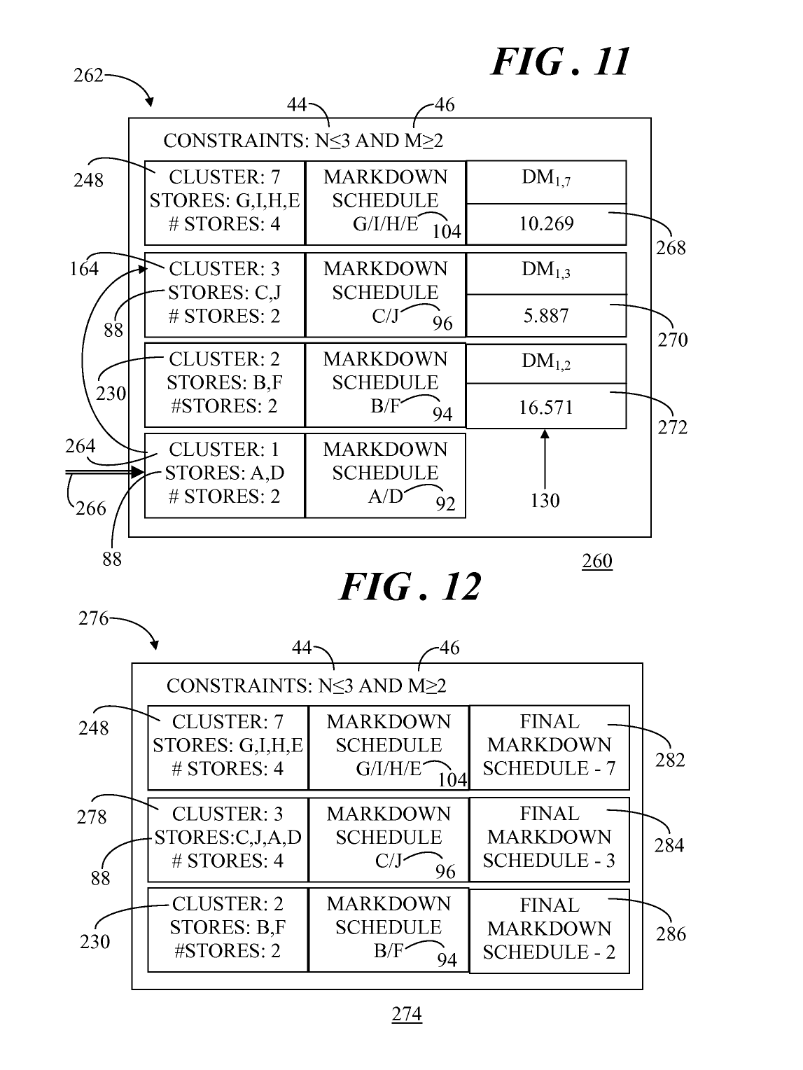

FIG. 11 shows a diagram 260 of a seventh iteration 262 of store categorization subprocess 60 of markdown definition process 52. As a result of sixth iteration 246 (FIG. 10), a joint store cluster 264 containing two stores 24 having store identifiers 88 of “A” and “D” has been formed. At sorting task 114, joint store cluster 264 is sorted to a position that is last in the descending order of store clusters. As such, joint store cluster 264 is identified as the last store cluster at task 122 as represented by an arrow 266.

Task 124 is executed to compute distortion metric values 268, 270, and 272 between markdown schedule 92 for store cluster 264 and each of markdown schedules 104, 96, and 94 for remaining store clusters 248, 164, and 230. The candidate store cluster having the lowest distortion metric value is selected at task 154. At seventh iteration 262, the candidate store cluster is store cluster 164 having the lowest distortion metric value 270.

Task 156 is executed to combine the last store cluster with the candidate store cluster. Thus, store cluster 264 is combined (agglomerated) with store cluster 164 at seventh iteration 262 to form a joint store cluster that contains all stores 24 in store clusters 264 and 164. These stores 24 are identified by store identifiers 88 of “C,” “J,” “A,” and “D.” Task 158 is then executed to determine a joint markdown schedule for the newly formed joint store cluster. In keeping with the methodology discussed above, markdown schedule 96 for store cluster 164 will be imposed on the newly formed joint store cluster. Again, program control loops back to query task 112 to determine whether both user imposed constraints, namely, maximum store cluster limit 44 and minimum stores limit 46 have been satisfied.

FIG. 12 shows a diagram 274 of a final outcome 276 of store categorization subprocess 60 of markdown definition process 52. As a result of seventh iteration 262 (FIG. 11), a joint store cluster 278 containing four stores 24 having store identifiers 88 of “C,” “J,” “A,” and “I)” has been formed.

Now with continued reference to FIGS. 2 and 12, at query task 112, a determination can be made that the total quantity of store clusters is less than or equal to maximum store cluster limit 44. That is, as represented by diagram 274, there are there remaining store clusters, i.e., joint store clusters 248, 278, and 230. Accordingly, markdown definition process 52 continues with query task 116. At query task 116, a determination can be made that the total quantity of stores 24 in each store cluster is greater than or equal to minimum store limit 46. Accordingly, markdown definition process 52 proceeds to task 118. Thus, store categorization subprocess 60 iterates until two conditions are met 1) the total number of store clusters does not exceed the specified maximum number of store clusters, and 2) the membership in each store cluster (store count) is greater than or equal to the minimum specified number of stores for each store cluster.

At task 118, the remaining joint store clusters 248, 278, and 230 are exported from store categorization subprocess 60.

In response to task 118, markdown definition process 52 continues with a task 280. At task 280, markdown optimization code 48 (FIG. 1) is executed for each of the store clusters produced through the execution of store categorization subprocess 60. That is, after achieving the desired number of store clusters with at least the minimum number of stores in each cluster, optimization task 280 re-optimizes markdown schedules (either dates or depths or both).

With continued reference to FIG. 2 and to the example presented in FIG. 12, store categorization subprocess 60 uses a heuristic method of minimum distortion agglomeration to define store clusters, e.g., joint store clusters 248, 278, and 230, but does not guarantee that the associated markdown schedules 104, 96, and 94 are optimal for all of the products and stores 24 (FIG. 1) within each of store clusters 248, 278, and 230. Task 280 ensures both that business rules are properly enforced and maximum value is delivered for the store clusters (in this example, store clusters 248, 278, and 230) produced by the clustering algorithm of store categorization subprocess 60. Thus, a final markdown schedule 282 is produced for store cluster 248, a final markdown schedule 284 is produced for store cluster 278, and a final markdown schedule 286 is produced for store cluster 230.

Referring back to FIG. 2, following execution of markdown optimization code 48 at task 280, markdown definition process 52 continues with a task 288. At task 288, computing system 20 (FIG. 1) provides the final markdown schedules to stores 24 (FIG. 1). In particular, each of stores 24 categorized into a particular store cluster receives the same markdown schedule. In the example shown in FIG. 12, stores 24 categorized into store cluster 248 and labeled “G,” “I,” “H,” and “E” are provided with final markdown schedule 282. Stores 24 categorized into store cluster 278 and labeled “C,” “J,” “A,” and “D” are provided with final markdown schedule 284, and stores 24 categorized into store cluster 230 and labeled “B” and “F” are provided with final markdown schedule 286.

Following task 288, markdown definition process 52 ends. However, markdown definition process 52 can be readily executed again in order to recategorize stores 24 into updated store clusters for another nmarkdown event 22 (FIG. 1) taking into account store-based inventory, item elasticity, sales data, and consumer demand.

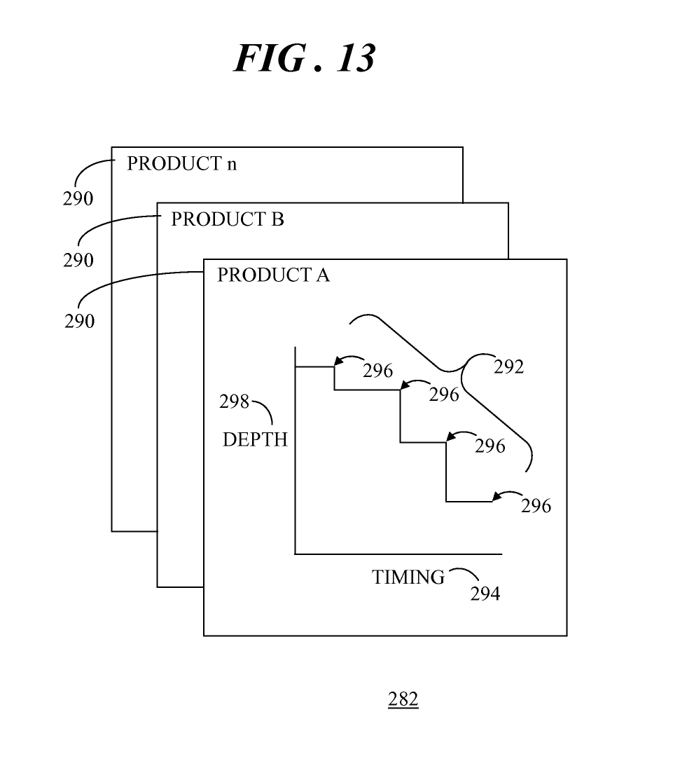

FIG. 13 shows a diagram of an exemplary final markdown schedule provided to one of the store clusters. In this illustration, the final markdown schedule is final markdown schedule 282 defined for markdown event 22 (FIG. 1) and provided to stores 24 categorized into store cluster 248 (FIG. 12). In this example, final markdown schedule 282 includes a listing of products 290 (e.g., Product A, Product B, through Product n) and their associated markdown sequence 292, timing 294, and markdown prices 296 for markdown event 22.

Markdown sequence 292 generally refers to the order of markdown prices 296 (e.g., 25%, 50%, 75% off, or $11.99, $9.99, $5.99). That is, markdown sequence 292 refers to the set and order of markdown prices 296 without explicitly referring to dates. Markdown prices 296 may be defined in terms of their depth 298. Depth 298 refers to the depth of discount, usually expressed in terms of percent off of regular price. Accordingly, markdown pricing of 50% has greater depth (i.e., is a “deeper cut”) than markdown pricing of 25%. Timing 294 generally refers to the dates on which markdowns are taken. That is, timing 294 refers to the time at which markdown prices 296 are taken without explicitly referring to the specific markdown prices 296 or depths 298. Thus, final markdown schedule 282 represents optimized markdown solutions for products 290 eligible for markdown event 22 specific to the newly created store cluster 248 (FIG. 12) containing stores 24 labeled “G,” “I,” “H,” and “E.”

Final markdown schedule 282 is presented herein for illustrative purposes. Those skilled in the art will recognize that final markdown schedules can include more or less information than that shown in accordance with user-specified preferences. Furthermore, the specific information provided in the final markdown schedules can be provided in a great variety of formats.

Embodiments described herein entail a system, a computer-readable storage medium containing executable code, and methodology for defining a markdown event for a plurality of stores. In particular, the system, executable code, and methodology allow a large markdown event consisting of many products and stores to be clustered in order to maximize value, subject to a constraint in the allowable number of distinct markdown schedules. The stores are clustered by markdown event to reflect store-based inventory, item elasticity, and consumer demand. Consequently, each store within a store cluster receives a common markdown schedule, i.e., the specification of dates and marks (e.g., prices, amount off marks, or percent off marks), for a markdown event. The stores are clustered in such a way so as to maximize the performance of markdown optimization for the resulting store clusters. Furthermore, the store clusters can be dynamically recategorized to take into account current inventories and sales data.

Although the preferred embodiments of the invention have been illustrated and described in detail, it will be readily apparent to those skilled in the art that various modifications may be made therein without departing from the spirit of the invention or from the scope of the appended claims. For example, the process operations may be performed in a different order then that described.

What is claimed is:

1. A method of defining a markdown event for a plurality of stores comprising:
computing initial markdown schedules for products eligible for said markdown event, one each of said initial markdown schedules being specific to one each of a plurality of stores;
categorizing said stores into store clusters in accordance with said initial markdown schedules;
determining final markdown schedules for said markdown event, one each of said final markdown schedules being created for one each of said store clusters, said final markdown schedules including optimized markdown solutions for said products eligible for said markdown event, wherein said computing, categorizing, and determining operations are performed at a computing system; and
providing, from said computing system, said final markdown schedules to said plurality of stores such that each of said stores categorized in one of said store clusters receives the same one of said final markdown schedules.

2. A method as claimed in claim 1 wherein said computing operation comprises executing a markdown optimization process at said computing system to obtain said initial markdown schedules.

3. A method as claimed in claim 1 wherein said categorizing operation comprises utilizing said initial markdown schedules to perform an agglomerative hierarchical clustering process to group said stores into said store clusters.

4. A method as claimed in claim 3 wherein said utilizing operation comprises:
sorting said store clusters in a descending order;
identifying a last store cluster from said descending order of said store clusters;
computing distortion metrics that relate said last store cluster to remaining ones of said store clusters;
selecting a candidate store cluster from said remaining store clusters, said candidate store cluster having a lowest computed one of said distortion metrics;
combining said last store cluster with said candidate store cluster to form a joint store cluster, said joint store cluster including all of said stores in said last store cluster and said candidate store cluster; and
determining a joint markdown schedule for said joint store cluster.

5. A method as claimed in claim 4 wherein:
said sorting operation sorts said store clusters in said descending order of a cluster size, said cluster size describing a quantity of stores categorized in each of said store clusters; and
said identifying operation selects one of said store clusters having a lowest cluster size as being said last store cluster.

6. A method as claimed in claim 4 wherein one each of said distortion metrics is computed as a comparison between a first markdown schedule specific to said last store cluster and a second markdown schedule specific to one of said remaining store clusters, said first markdown schedule being one of said initial markdown schedule and a current joint markdown schedule for said last store cluster, and said second markdown schedule being one of said initial markdown schedule and said current joint markdown schedule for said one of said remaining store clusters.

7. A method as claimed in claim 4 further comprising repeating said sorting, identifying, computing, selecting, combining, and determining operations to ascertain said joint markdown schedule specific to each of said store clusters.

8. A method as claimed in claim 1 further comprising constraining a total quantity of said store clusters to a maximum store cluster limit, wherein said categorizing operation forms said store clusters so that said total quantity of said store clusters is no greater than said maximum store cluster limit.

9. A method as claimed in claim 8 further comprising enabling a user to define said maximum store cluster limit.

10. A method as claimed in claim 1 further comprising constraining a total store count for each of said store clusters to a minimum stores limit, wherein said categorizing operation forms said store clusters so that said total store count in said each of said store clusters is at least equal to said minimum stores limit.

11. A method as claimed in claim 10 further comprising enabling a user to define said minimum stores limit.

12. A method as claimed in claim 1 wherein said optimized markdown solutions in each of said final markdown schedules defines dates and markdown sequences for said products eligible for said markdown event.

13. A system for defining a markdown event for a plurality of stores comprising:
a processor;
a computer-readable storage medium; and
executable code recorded on said computer-readable storage medium for instructing said processor to perform operations comprising:
computing initial markdown schedules for products eligible for said markdown event, one each of said initial markdown schedules being specific to one each of a plurality of stores;
categorizing said stores into store clusters in accordance with said initial markdown schedules, wherein said categorizing operation forms said store clusters so that a total quantity of said store clusters is no greater than a maximum store cluster limit and a number of said stores in said each of said store clusters is at least equal to a minimum stores limit;
determining final markdown schedules for said markdown event, one each of said final markdown schedules being created for one each of said store clusters, said final markdown schedules including optimized markdown solutions for said products eligible for said markdown event; and
providing, from said system, said final markdown schedules to said plurality of stores such that each of said stores categorized in one of said store clusters receives the same one of said final markdown schedules.

14. A system as claimed in claim 13 wherein said executable code instructs said processor to perform a further operation of said computing operation comprising executing a markdown optimization process at said computing system to obtain said initial markdown schedules.

15. A system as claimed in claim 13 wherein said executable code instructs said processor to perform a further operation comprising utilizing said initial markdown schedules to perform an agglomerative hierarchical clustering process to categorize said stores into said store clusters, wherein said agglomerative hierarchical clustering process iterates until said total quantity of said store clusters is less than or equal to said maximum store cluster limit and said number of said stores in said each of said store clusters is no less than said minimum stores limit.

16. A system as claimed in claim 13 further comprising an input element coupled to said processor for receiving said maximum store cluster limit from a user.

17. A system as claimed in claim 13 further comprising an input element coupled to said processor for receiving said minimum stores limit from a user.

18. A computer-readable storage medium containing executable code for defining a markdown event for a plurality of stores, said executable code instructing a processor to perform operations comprising:
computing initial markdown schedules for products eligible for said markdown event, one each of said initial markdown schedules being specific to one each of a plurality of stores;
categorizing said stores into store clusters, said categorizing operation including:
utilizing said initial markdown schedules to perform an agglomerative hierarchical clustering process to group said stores into said store clusters; and
constraining a total quantity of said store clusters to a maximum store cluster limit so that said total quantity of said store clusters is no greater than said maximum store cluster limit;
determining final markdown schedules for said markdown event, one each of said final markdown schedules being created for one each of said store clusters, said final markdown schedules including optimized markdown solutions for said products eligible for said markdown event; and
providing, from said processor, said final markdown schedules to said plurality of stores such that each of said stores categorized in one of said store clusters receives the same one of said final markdown schedules.

19. A computer-readable storage medium as claimed in claim 18 wherein said executable code instructs said processor to perform operations of said utilizing operation comprising:
sorting said store clusters in a descending order;
identifying a last store cluster from said descending order of said store clusters;
computing distortion metrics that relate said last store cluster to remaining ones of said store clusters;
selecting a candidate store cluster from said remaining store clusters, said candidate store cluster having a lowest computed one of said distortion metrics;
combining said last store cluster with said candidate store cluster to form a combined store cluster, said combined store cluster including all of said stores in said last store cluster and said candidate store cluster; and
determining said joint markdown schedule for said combined store cluster.

20. A computer-readable storage medium as claimed in claim 18 wherein said executable code instructs said processor to perform said computing operation such that one each of said distortion metrics is computed as a comparison between a first markdown schedule specific to said last store cluster and a second markdown schedule specific to one of said remaining store clusters, said first markdown schedule being one of said initial markdown schedule and a current joint markdown schedule for said last store cluster, and said second markdown schedule being one of said initial markdown schedule and said current joint markdown schedule for said one of said remaining store clusters.
